(19) United States
(12) Patent Application Publication
(10) Pub. No.: US 2011/0203947 A1
(43) Pub. Date: Aug. 25, 2011

(54) FUEL TANK AND EVAPORATED FUEL PROCESSING DEVICE INCLUDING THE FUEL TANK

(75) Inventor: Yoshihide Ogawa, Toyota-Shi (JP)

(73) Assignee: Toyota Jidosha Kabushiki Kaisha, Toyota-Shi (JP)

(21) Appl. No.: 13/032,705

(22) Filed: Feb. 23, 2011

(30) Foreign Application Priority Data
Feb. 23, 2010 (JP) JP2010-037538

(51) Int. Cl. B65D 88/74; F02M 37/20

(52) U.S. Cl. 206/216

(57) ABSTRACT

A latent heat storage material, in which a phase-change substance that changes its phase from a solid to a liquid when the temperature of stored fuel rises, is disposed in a fuel tank of the present invention.

### CROSS-REFERENCE TO RELATED APPLICATIONS

This application claims priority to Japanese Patent Application No. 2010-037538 filed on Feb. 23, 2010, which is incorporated herein by reference in its entirety including the specification, drawings and abstract.

### BACKGROUND OF THE INVENTION

1. Field of the Invention

The present invention relates to a fuel tank that stores a liquid fuel and further to an evaporated fuel processing device that includes the fuel tank.

2. Description of the Related Art

In the fuel tank that stores liquid fuel, the fuel is evaporated from its surface and a fuel vapor is formed in the fuel tank. Japanese Patent Application Publication No. 2004-308483 (JP-A-2004-308483) discloses an evaporated fuel processing device in which a fuel vapor formed in the fuel tank is introduced to an intake passage of an internal combustion engine to be burned therein while the engine is running. In such evaporated fuel processing device, the fuel vapor formed in the tank is introduced to a canister and then adsorbed temporarily on an adsorbent installed in the canister. Then, the air in the canister is suctioned out into the intake passage, and at the same time the outside air is introduced from an outside air introduction passage into the canister. In this way the adsorbed fuel is purged from the adsorbent and introduced to the intake passage together with the air, and then burned in the internal combustion engine. Accordingly, the fuel vapor formed in the fuel tank can be removed by combustion without a leak into the outside air.

However, when a fuel temperature in the fuel tank rises along with a temperature rise in the outside air, the fuel in the fuel tank become evaporated more rapidly. In this case, a significant amount of fuel vapor is adsorbed on the adsorbent, and the adsorbent becomes saturated more easily. Once the adsorbent becomes saturated, additional fuel vapor cannot be accepted, and therefore the fuel vapor passes through the canister and is released into the outside air from the outside air introduction passage.

Incidentally, saturation of the adsorbent can be prevented by installing a canister that has a large adsorbent capacity. However, in this case the canister and the evaporated fuel processing device need to be upsized.

Therefore, for the purpose of preventing the canister from upsizing and also effectively preventing the fuel vapor from leaking into the outside air, it is preferable that the fuel vapor is prevented from being formed in the first place.

### SUMMARY OF THE INVENTION

The present invention provides a fuel tank that prevents the forming of the fuel vapor, and an evaporated fuel processing device that includes the fuel tank.

In the first aspect of the present invention, a fuel tank for storing a liquid fuel is provided therein with a latent heat storage material that encloses a phase-change substance which changes a phase from a solid to a liquid when a temperature of a stored fuel rises.

The fuel stored in the fuel tank becomes more volatile as its temperature goes up. That is, when the fuel temperature becomes higher, the more amount of fuel vapor is formed in the fuel tank.

In the above aspect, the fuel tank is provided with the latent heat storage material in which a phase-change substance that changes a phase from a solid to a liquid when the fuel temperature rises is enclosed.

The phase-change from a solid to a liquid is an endothermic reaction that adsorbs heat from its environment by the function of the latent heat. When the temperature of the fuel stored in the fuel tank goes up due to the temperature rise of the outside air for example, the phase-change substance changes its phase from a solid to a liquid, and accordingly the temperature rise of the fuel is prevented by the latent heat.

According to the above aspect, the temperature rise of the fuel and resultant volatilization of the fuel are prevented, and thus the forming of the fuel vapor is prevented. Incidentally, the latent heat storage material may be formed by enclosing the phase-change substance in a metallic container. If this construction is adopted, in which the phase-change substance is enclosed in the metallic container, the phase-change substance in the liquid state is prevented from being mixed with the fuel. Because of this, the latent heat storage material can have a repeatably usable form.

As the phase-change substance, paraffinic hydrocarbon may be used. For example, for the purpose of preventing the fuel temperature rise caused by the change in outside air temperature, substances, which have a melting point around the outside air temperature (for example 0° C. to 40° C.), may be used as the phase-change substance.

Some of the paraffinic hydrocarbon have a melting point in the above temperature range. Therefore, for the purpose of preventing the fuel temperature rise caused by the change in the outside air temperature, paraffinic hydrocarbons, which have the melting point around the outside air temperature, may be used as the phase-change substance.

In the fuel tank according to the above aspect, the latent heat storage material may be fixed to the bottom surface on the inside of the fuel tank. The latent heat storage material should not be fixed to the upper portion of the fuel tank because when the amount of fuel stored in the fuel tank is low, the latent heat storage material does not come in contact with the fuel and as a result the effect of preventing the fuel temperature rise cannot be obtained.

On the other hand, if the latent heat storage material is fixed to the bottom surface on the inside of the fuel tank, the latent heat storage material keeps in contact with the fuel even when the amount of fuel stored in the fuel tank becomes low. For this reason, the temperature rise of fuel is effectively prevented by the use of the latent heat of the phase-change substance even when the amount of fuel stored in the fuel tank becomes low.

In the fuel tank in which the pump module is arranged to be immersed in the stored fuel, the latent heat storage material may be fixed to a portion of the pump module. In this case, the temperature rise of fuel can be prevented by the use of the latent heat of the phase-change substance as long as the latent heat storage material fixed to the pump module is immersed in the stored fuel.

In the case where the latent heat storage material is fixed to the pump module, the latent heat storage material may be fixed to the wall surface of a reserve cup.

In another aspect of the present invention, an evaporated fuel processing device includes: the fuel tank; a canister that includes an adsorbent for adsorbing a fuel vapor; a discharge passage that connects the fuel tank and the canister; a purge passage that connects an intake passage of an internal combustion engine and the canister; and an outside air introduction passage that introduces air into the canister. The air in the canister is suctioned out into the intake passage by using a negative pressure in the intake passage, then air is introduced through the outside air introduction passage into the canister, thereby the fuel vapor adsorbed on the adsorbent is purged, and the purged fuel vapor is introduced in the intake passage together with the air to be burned in the internal combustion engine while the engine is running.

Once a large amount of fuel is adsorbed onto the adsorbent and the adsorbent becomes saturated, the adsorbent cannot adsorb the fuel any further. If it happens, the fuel vapor is passed through the canister and discharged into the outside air from the outside air introduction passage. As a remedy for this, a large capacity adsorbent can be installed in the canister in order to prevent the adsorbent from becoming saturated. Disappointedly, in such a construction the canister must be upsized and also the evaporated fuel processing device must be upsized.

Fortunately, the evaporated fuel processing device of the present invention is provided with a fuel tank that can prevent the temperature rise of the fuel and the forming of the fuel vapor. Therefore, saturation of the adsorbent can be prevented without installing a canister that has a large adsorbent capacity. That is, according to the evaporated fuel processing device described herein, the adsorbent can be prevented from being saturated while the upsizing of the canister and the evaporated fuel processing device is prevented.

In the evaporated fuel processing device of the above aspect, a closing valve that closes the discharge passage while the engine is not running may further be provided, and the fuel tank may be sealed hermetically while the engine is not running.

Some of the evaporated fuel processing devices of the related technique have a mechanism in which the discharge passage is closed and the fuel tank is hermetically sealed when the engine is not running and the purge is not executed. According to this construction in which the fuel tank is hermetically sealed while the engine is not running, the fuel vapor is not introduced to the canister while the discharge passage is closed. Thus, the adsorbent is prevented from being saturated and the fuel vapor is prevented from being passed through the canister and discharged into the outside air.

However, when the fuel tank is hermetically sealed, the fuel vapor cannot escape from the fuel tank, and as a result the pressure in the fuel tank increases along with the fuel vaporization. For that reason, if the above construction is used in which the fuel tank is hermetically sealed, the fuel tank must have the strength to withstand the pressure increase. Unfortunately, when the material thickness of the fuel tank is increased, the weight and the manufacturing cost of the fuel tank must be increased.

On the other hand, with the evaporated fuel processing device including the fuel tank according to the first aspect of the present invention in which the temperature rise of the fuel is prevented and the forming of the fuel vapor is prevented, the pressure increase caused by the forming of the fuel vapor can be prevented, so that the strength of the tank material to withstand the pressure increase can easily be secured.

That is, according to the evaporated fuel processing device of the other aspect of the present invention, the fuel tank can be hermetically sealed, so that the adsorbent can be prevented from being saturated, and the fuel vapor can be prevented from being discharged through the canister into the outside air, while the weight and manufacturing cost of the fuel tank needed for securing the strength is not increased.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a schematic view that illustrates a schematic construction of an evaporated fuel processing device according to an embodiment of the present invention;

FIG. 2 is a cross-sectional view of a latent heat storage material that is disposed in a fuel tank of the evaporated fuel processing device according to the same embodiment;

FIGS. 3A, 3B, and 3C are explanatory drawings that illustrate a fixing method of the latent heat storage material;

FIGS. 4A and 4B are explanatory drawings that illustrate another fixing method of the latent heat storage material;

FIG. 5 is a schematic view that illustrates a state in which the latent heat storage material is fixed to a pump module;

### DETAILED DESCRIPTION OF THE PREFERRED EMBODIMENTS

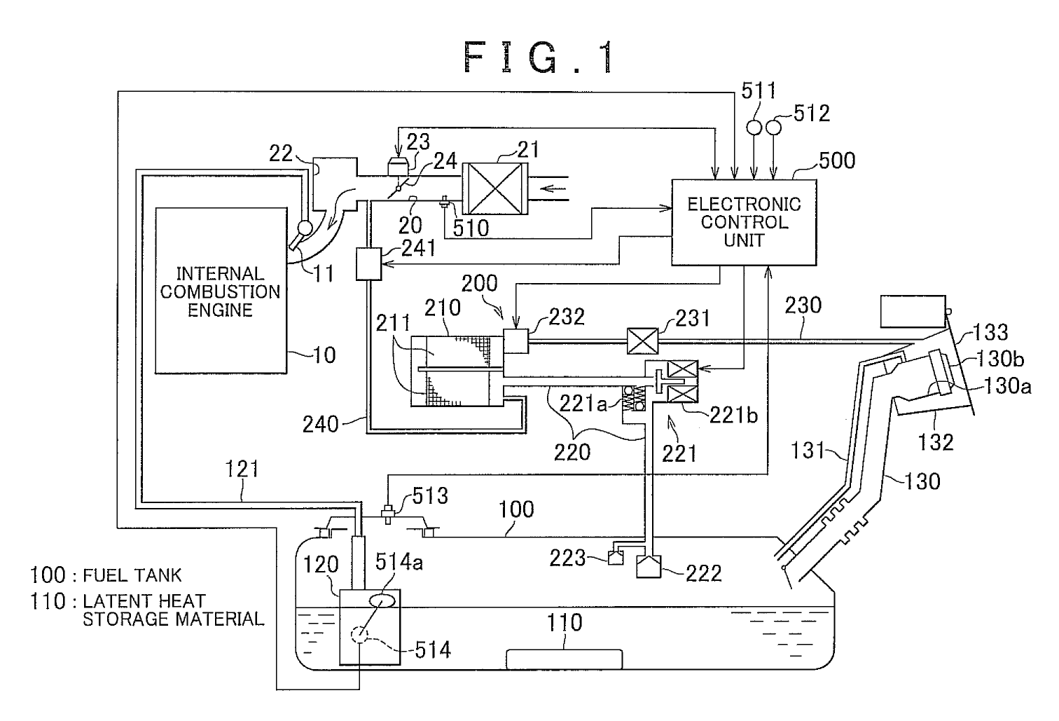

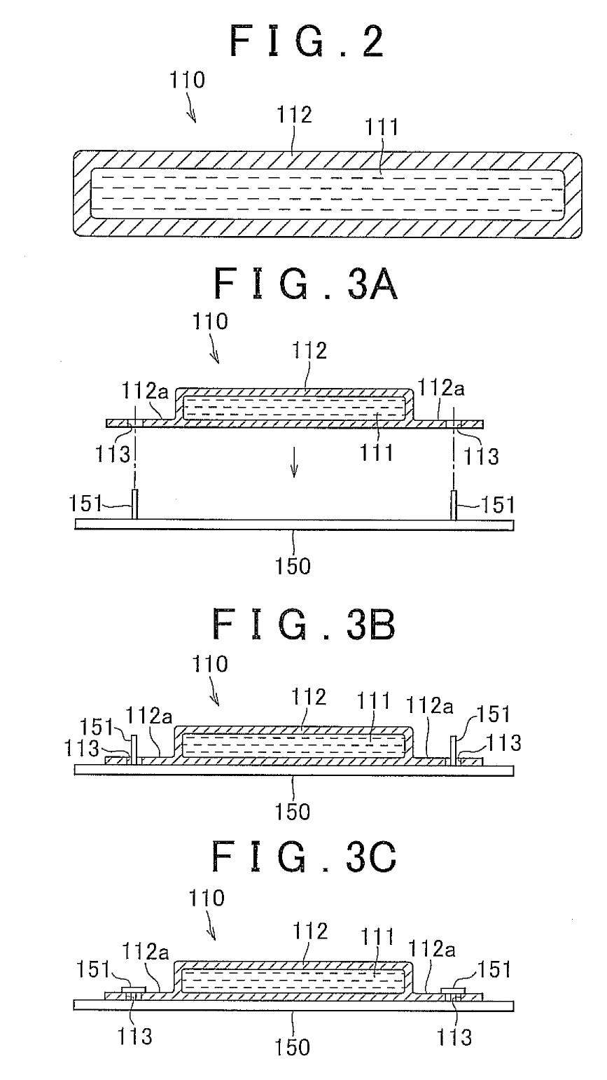

Hereinafter, with reference to FIG. 1 and FIG. 2, an embodiment will be described, in which the fuel tank and the evaporated fuel processing device that includes the fuel tank according to the present invention are embodied as the fuel tank and the evaporated fuel processing device installed in a vehicle. FIG. 1 shows a schematic construction of an evaporated fuel processing device 200 according to the present embodiment.

As shown in a lower portion of FIG. 1, a fuel tank 100 is provided with a pump module 120 that pumps up the fuel stored in the fuel tank 100. A pressure sensor 513 that detects a pressure in the fuel tank 100 is disposed on the upper portion of the fuel tank 100.

The pump module 120 is connected through a fuel supply 121 to a fuel injection valve 11 of an internal combustion engine 10. Accordingly, the fuel, which is pumped up from the fuel tank 100 by the pump module 120, is supplied through the fuel supply pipe 121 to the fuel injection valve 11. The fuel module 120 is provided with a fuel sender gauge 514 that detects a fuel level stored in the fuel tank 100 corresponding to the position of a float 514a floating on the fuel stored in the fuel tank 100.

A fuel inlet pipe 130 is connected to the fuel tank 100 as shown on the right side of FIG. 1. A filler opening 130a located on the end of the fuel inlet pipe 130 is housed in a fuel inlet box 132 disposed in a vehicle body. The fuel inlet pipe 130 is provided with a circulation pipe 131 that connects the upper portion of the fuel tank 100 and the upstream portion of the fuel inlet pipe 130.

The fuel inlet box 132 is provided with a fuel lid 133. Fuel can be fed through the filler opening 130a into the fuel tank 100 by opening the fuel lid 133 and by removing a cap 130b placed on the filler opening 130a.

As shown in the upper portion of FIG. 1, an intake passage 20 of the internal combustion engine 10 is provided with the fuel injection valve 11 that injects the fuel supplied from the fuel tank 100. An inlet portion of the intake passage 20 is provided with an air filter 21 to remove fine dust contained in the suction air.

On the upstream side of the surge tank 22 in the intake passage 20, there is provided a throttle valve 24 that is regulated by a motor 23 for its degree of opening and that regulates a suction air amount GA which is the amount of air suctioned into the internal combustion engine 10. The upstream portion of the throttle valve 24 in the intake passage 20, there is also provided an air flow meter 510 that detects the suction air amount GA.

As shown in the center of FIG. 1, to the intake passage 20 of the internal combustion engine 10, the evaporated fuel processing device 200 that processes the fuel vapor formed in the fuel tank 100 is connected. The evaporated fuel processing device 200 includes a canister 210 that contains an adsorbent 211 that adsorbs fuel vapor. Incidentally, the adsorbent 211 is made of activated carbon that absorbs the fuel.

The canister 210 is connected through the discharge passage 220 to the upper portion of the fuel tank 100. As shown in FIG. 1, a closing valve unit 221 is disposed in the middle of the discharge passage 220. The closing valve unit 221 includes: a relief valve 221a that opens when a pressure difference between the upstream portion and the downstream portion of the valve unit 221 becomes significantly large; and a closing valve 221b that opens or closes a passage that bypasses the relief valve 221a. Incidentally, the closing valve 221b is a magnetically driven valve that can be switched between the open state and the closed state based on the control command of an electronic control unit 500.

The discharge passage 220 is provided with such a closing valve unit 221, so that when the closing valve 221b is closed, the discharge passage 220 becomes closed by the relief valve 221a and the closing valve 221b.

As shown in the lower portion of FIG. 1, the inlet portion of the discharge passage 220 in the fuel tank 100 is provided with an ORVR (On-Board Refueling Vapor Recovery) valve 222 and a roll over valve 223.

The ORVR valve 222 opens when the fuel is fed and the fuel level is raised to cause the pressure increase in the fuel tank 100. When the fuel level and the pressure level in the fuel tank 100 are increased, the fuel vapor in the fuel tank 100 is introduced through the discharge passage 220 to the canister 210. Thus, the pressure increase in the fuel tank 100 caused by the rising of the fuel level is prevented, and therefore, when the fuel is fed, the fuel vapor is prevented from being discharged through the fuel inlet pipe 130 and the circulation pipe 131 into the outside air.

On the other hand, the roll over valve 223 is closed when the vehicle is sharply tilted, and the liquid fuel is prevented from leaking to the outside of the fuel tank 100. The fuel vapor in the fuel tank 100 is introduced through the discharge passage 220 to the canister 210 when at least one of the relief valve 221a and the closing valve 221b is open and when at least one of the ORVR valve 222 and the roll over valve 223 is open. Then, the fuel vapor introduced to the canister 210 is adsorbed to the adsorbent 211.

To the canister 210, an outside air introduction passage 230 that communicates with the fuel inlet box 132 disposed on the vehicle body is connected. An air filter 231 is disposed in the middle of the outside air introduction passage 230. Incidentally, the downstream portion of the air filter 231 in the outside air introduction passage 230 is provided with a negative pressure pump unit 232 that functions as a switcher to switch the passage state between, closing the outside air introduction passage 230, and communicating the canister 210 to the fuel inlet box 132 without closing the outside air introduction passage 230.

Furthermore, to the canister 210, a purge passage 240 that communicates with the intake passage 20 is connected. As shown in FIG. 1, a purge control valve 241, which is switched between the open state and the closed state based on the command from the electronic control unit 500, is disposed in the middle of the purge passage 240.

To the electronic control unit 500 that controls the vehicle comprehensively, above-mentioned devices such as the air flow meter 510, the pressure sensor 513, and the fuel sender gauge 514 are connected, and also various other sensors such as an accelerator position sensor 511 that detects the amount of accelerator operation by a driver and a crank position sensor 512 that detects an engine rotational speed NE are connected.

The electronic control unit 500 outputs a command signal based on the signal output from these various sensors, and comprehensively controls the individual sections of the vehicle such as the evaporated fuel processing device 200. For example when the engine is running, the electronic control unit 500 controls the motor 23 based on the engine rotational speed NE detected by the crank position sensor 512 and based on the accelerator operational amount detected by the accelerator pedal position sensor 511, and accordingly drives the throttle valve 24 in order to regulate the suction air amount GA. Also, the electronic control unit 500 controls the valve opening time of the fuel injection valve 11 based on the suction air amount GA to control the fuel injection amount.

Also while the engine is running, the electronic control device 500 controls the evaporated fuel processing device 200 to purge the fuel adsorbed on the adsorbent 211 of the canister 210, and then introduces the purged fuel into the intake passage 20 together with the air.

Specifically, while the engine is running, the electronic control unit 500 opens the purge control valve 241, and lets the air in the canister 210 be suctioned through the purge passage 240 into the intake passage 20 by the negative pressure in the intake passage 20.

Then, the electronic control unit 500 switches the negative pump unit 232 to the state where the canister 210 is communicated to the fuel inlet box 132 while the outside air introduction passage 230 is not closed, thereby introducing the air through the outside air introduction passage 230 into the canister 210. Accordingly, the fuel adsorbed on the adsorbent 211 is purged, and the purged fuel is introduced through the purge passage 240 to the intake passage 20 together with the air.

By conducting such a purge action appropriately while the engine is running, the fuel adsorbed on the adsorbent 211 is purged from the adsorbent 211. Therefore, the adsorbent 211 is prevented from being saturated. Also, the purged fuel is introduced to the intake air passage 20 together with the air and burned in the internal combustion engine 10. Therefore, the fuel vapor formed in the fuel tank 100 can be burned and removed without being released into the outside air.

In the evaporated fuel processing device 200 of the present embodiment, while the engine is not running except for when the fuel is fed, the closing valve 221b is closed in order to close the discharge passage 220. Accordingly, while the engine is not running, the fuel tank 100 is hermetically sealed basically, and the fuel vapor is not introduced to the canister 210 as long as the pressure in the fuel tank 100 does not exceed the threshold of opening the relief valve 221a.

Accordingly, while the engine is not running and the purge is not executed, the fuel vapor is not adsorbed on the adsorbent 211 of the canister 210, and thus the adsorbent 211 is prevented from being saturated. Also, the fuel tank 100 is hermetically sealed in this way while the engine is not running, so that the fuel vapor is prevented from being passed through the canister to be released into the outside air without being adsorbed on the adsorbent.

However, while the fuel tank 100 is hermetically sealed, the fuel vapor formed in the fuel tank 100 cannot escape anywhere, so the pressure in the fuel tank 100 starts increasing when the fuel vapor is formed.

If the cap 130b is removed to open the filler opening 130a in the state that the pressure in the fuel tank is higher than the outside air, the fuel vapor in the fuel tank 100 is released into the outside air through the fuel inlet pipe 130. As a remedy for this, the evaporated fuel processing device 200 of the present invention prevents the fuel vapor from being released into the outside air by the following method. First, the fuel vapor in the fuel tank is opened and the fuel vapor in the fuel tank 100 is introduced through the discharge passage 220 to the canister 210 in order to reduce the pressure in the fuel tank 100. Then, the pressure in the fuel tank 100 is checked by the pressure sensor 513 to see if it is sufficiently lowered. If the pressure is at the satisfactory level, the fuel lid 133 is unlocked.

By using the above mentioned method in which the fuel lid 133 is unlocked after the sufficiently low pressure in the fuel tank 100 is confirmed, the fuel vapor in the fuel tank 100 is prevented from being discharged through the fuel inlet pipe 130 to the outside air when the filler opening 130a is opened.

By the way, when the fuel temperature in the fuel tank 100 becomes high because of a temperature rise in the outside air, the fuel in the fuel tank 100 become evaporated more rapidly. In this case, a significant amount of fuel vapor is adsorbed on the adsorbent 211. Therefore, when the fuel temperature is high, the adsorbent 211 is saturated more easily. Once the adsorbent 211 becomes saturated, it cannot receive any more of the fuel vapor. Consequently, the fuel vapor is passed through the canister 210 and released into the outside air from the outside air introduction passage 230.

Incidentally, saturation of the adsorbent 211 can also be prevented by installing the canister 210 with a large adsorbent capacity. Unfortunately in this case, the canister 210 and the evaporated fuel processing device 200 need to be upsized.

Therefore, for the purpose of preventing the canister 210 from capsizing and also effectively preventing the fuel vapor from leaking into the outside air, it is preferred that the fuel vapor is prevented from being formed in the fuel tank 100 in the first place.

In the evaporated fuel processing device 200 of the present embodiment, as shown in the lower portion in FIG. 1, a latent heat storage material 110 is disposed in the fuel tank 100 in order to prevent the fuel temperature rise.

FIG. 2 is a cross-sectional view of the latent heat storage material 110 disposed in the fuel tank 100. As shown in FIG. 2, the latent heat storage material 110 is formed by enclosing a phase-change substance 111 in a metallic container 112.

In the latent heat storage material 110 according to the present embodiment, paraffinic hydrocarbon with a melting point between 0° C. to 40° C. is used as the phase-change substance 111 which is an enclosed material. Paraffinic hydrocarbons of this type include pentadecane with a melting point at 10° C., hexadecane with a melting point at 18° C., octadecane with a melting point at 28° C., and henicosane with a melting point at 40° C. In the latent heat storage material 110 according to the present embodiment, hexadecane, which has a melting point at 18° C. and has the relatively large latent heat per unit mass, is used as the phase-change substance 111.

The reason that the substance with the melting point between 0° C. to 40° C. is used as the phase-change substance 111 is, because it allows the phase-change from a solid to a liquid in the environment in which the vehicle is used, and because it prevents the fuel temperature rise effectively with the latent heat caused by the phase-change. That is, which substance to be used as the phase-change substance 111 can appropriately be selected based on the environment in which the vehicle is used.

Also, the phase-change substance 111 may be made from a mixture of substances. For example, an additive for adjusting a melting point may be added to suitably adjust the melting point to the operational environment, or an excess cooling preventive material may be added to increase the durability, or a phase-change preventive material may be added.

In the latent heat storage material 110 according to the present embodiment, the container 112 is formed with stainless steel. The reason that the phase-change substance 111 is enclosed in the stainless steel container 112 as described above is because stainless steel has a corrosion resistance against the fuel and can be processed easily.

In the fuel tank 100 of the present embodiment, the latent heat storage material 110, in which hexadecane as the phase-change substance 111 is enclosed in the stainless steel container 112, is fixed to the bottom surface on the inside of the fuel tank 100 as shown in FIG. 1.

Incidentally, the fuel tank 100 of the present embodiment is formed with a steel sheet, and the latent heat storage material 110 is fixed to the bottom surface of the fuel tank 100 by spot welding. According to the embodiment described above, the following effects can be obtained.

(1) The phase-change from a solid to a liquid is an endothermic reaction that absorbs heat from its environment by the function of the latent heat. When the temperature of the fuel stored in the fuel tank 100 goes up to exceed the melting point (18° C.) of the phase-change substance 111 for example because of the temperature rise of the outside air, the phase-change substance 111 enclosed in the latent heat storage material 110 is phase-changed from a solid to a liquid. At this time, the heat of the fuel is absorbed by the latent heat created when the phase-change substance 111 melts into a liquid, and the temperature rise of the fuel is prevented.

That is, according to the fuel tank 100 of the above embodiment, the temperature rise of fuel and resultant volatilization of the fuel are prevented, and thus the forming of the fuel vapor is prevented.

(2) The phase-change substance 111 is enclosed in the stainless steel container 112, so that the phase-change substance 111 in the melted liquid state is prevented from being mixed with the fuel. Also, stainless steel has higher thermal conductivity than resin and the like. Therefore, in the fuel tank 100 that is provided with the latent heat storage material 110 in which the phase-change substance 111 is enclosed in the stainless container 112 as described above, the heat is effectively conducted between the phase-change substance 111 and the fuel so as to effectively prevent the temperature rise of the fuel.

(3) The latent heat storage material 110 should not be fixed to the upper portion of the fuel tank 100. It is because when the amount of fuel in the fuel tank is low, the latent heat storage material 110 does not come in contact with the fuel, and thus the effect of preventing the fuel temperature rise cannot be obtained.

In the fuel tank 100 of the above embodiment, the latent heat storage material 110 is fixed to the bottom surface on the inside of the fuel tank 100. As a result, the latent heat storage material 110 keeps in contact with the fuel even when the amount of the fuel stored in the fuel tank 100 becomes low. Therefore, even when the amount of the fuel stored in the fuel tank 100 becomes low, the temperature rise of fuel can effectively be prevented by the latent heat from the phase-change substance 111.

(4) When the fuel becomes highly volatile with the temperature rise of the fuel, and when a large amount of the fuel is adsorbed on the adsorbent 211 to saturate the adsorbent 211, the adsorbent 211 cannot accept any more fuel, and the fuel vapor is passed through the canister 210 and discharged from the outside air introduction passage 230 without being adsorbed on the adsorbent 211.

As a remedy for this, a large capacity adsorbent 211 can be installed in the canister 210 in order to prevent the adsorbent 211 from becoming saturated. Disappointedly, in such a construction the canister 210 must be upsized and the evaporated fuel processing device 200 must also be upsized.

Fortunately, the evaporated fuel processing device 200 of the present embodiment is provided with a fuel tank 100 that can prevent the temperature rise of the fuel and the forming of the fuel vapor. As a result, the saturation of the adsorbent 211 can be prevented without installing the canister 210 with the large capacity adsorbent 211.

That is, according to the evaporated fuel processing device 200 of the above embodiment, the adsorbent 211 can be prevented from being saturated without upsizing the canister 210 and the evaporated fuel processing device 200.

(5) When the purge is executed, a negative pressure needs to be generated in the downstream portion of the throttle valve 24 in the intake passage 20, by reducing the degree of opening of the throttle valve 24 to increase the suction resistance of the air in the intake passage 20. That is, when the purge is executed, the internal combustion engine 10 is operated while a load is applied thereto. Therefore, when the purge is being executed, the fuel consumption is increased accordingly.

On the other hand, in the fuel tank 100 of the above embodiment, the frequency of purge execution can be reduced because the temperature rise of the fuel and the resultant generation of the fuel vapor can be prevented. Therefore, an increase in the fuel consumption along with the purging can be prevented.

(6) As in the evaporated fuel processing device 200 of the above embodiment, when the fuel tank 100 is hermetically sealed by closing the closing valve 221b while the engine is not running, the fuel vapor is not introduced to the canister 210 as long as the fuel tank 100 is hermetically sealed. Thus, the adsorbent 211 can be prevented from being saturated, and the fuel vapor can be prevented from being passed through the canister 210 and discharged into the outside air.

However, when the fuel tank 100 is hermetically sealed, the fuel vapor cannot escape from the fuel tank, and as a result the pressure in the fuel tank 100 increases along with the fuel vaporization. For this reason, in the construction in which the fuel tank 100 is hermetically sealed, the fuel tank needs to be built with the strength to withstand the pressure increase. However, if the material thickness of the fuel tank 100 is increased in order to secure the strength to withstand the pressure increase, the weight and the manufacturing cost of the fuel tank 100 are increased unfortunately.

On the other hand, if the construction, in which the fuel tank 100 is hermetically sealed while the engine is not running, is used for the evaporated fuel processing device 200 that is provided with the fuel tank 100, in which the latent heat storage material 110 is provided to prevent the fuel temperature rise and resultant fuel vapor generation, the pressure increase is prevented since the fuel temperature rise and the resultant forming of the fuel vapor are prevented. Therefore, the strength to withstand the pressure rise can be secured easily.

That is, according to the evaporated fuel processing device 200 of the present embodiment, the fuel tank 100 can be hermetically sealed, the adsorbent 211 can be prevented from being saturated, and the fuel vapor can be prevented from being discharged through the canister 210 into the outside air, while the increase in weight and manufacturing cost of the fuel tank 100 needed for securing the strength is prevented.

The above embodiment may be modified appropriately as described below.

In the above embodiment, the latent heat storage material 110 is fixed to the bottom surface of the steel sheet fuel tank 100 by welding. However, the fuel tank 100 of the present invention is not limited to be made of a steel sheet.

For example, the fuel tank of the present invention may be made of resin. However, if the latent heat storage material 110 is fixed to the resinous fuel tank, the method of fixing the latent heat storage material 110 needs to be modified because the latent heat storage material 110 cannot be welded to the resinous base.

For example, as shown in FIG. 3C, the latent heat storage material 110 can be fixed to the resinous fuel tank, if the latent heat storage material 110 is fixed to a resinous fixing plate 150 and then this resinous fixing plate 150 is bonded to the resinous fuel tank.

Incidentally, in order to integrally fix the fixing plate 150 and the latent heat storage material 110 as shown in FIG. 3C, a through hole 113 is created in a flange 112a of the container 112 of the latent heat storage material 110 and a resinous fixing pin 151 is provided in the fixing plate 150, as is well shown in FIG. 3A.

Then, as shown in FIG. 3B, the fixing pin 151 is passed through the through hole 113 created in the flange 112a. In this state, the fixing pin 151 is heated until it deforms. In this way, the latent heat storage material 110 and the fixing plate 150 may be integrally fixed as shown in FIG. 3C.

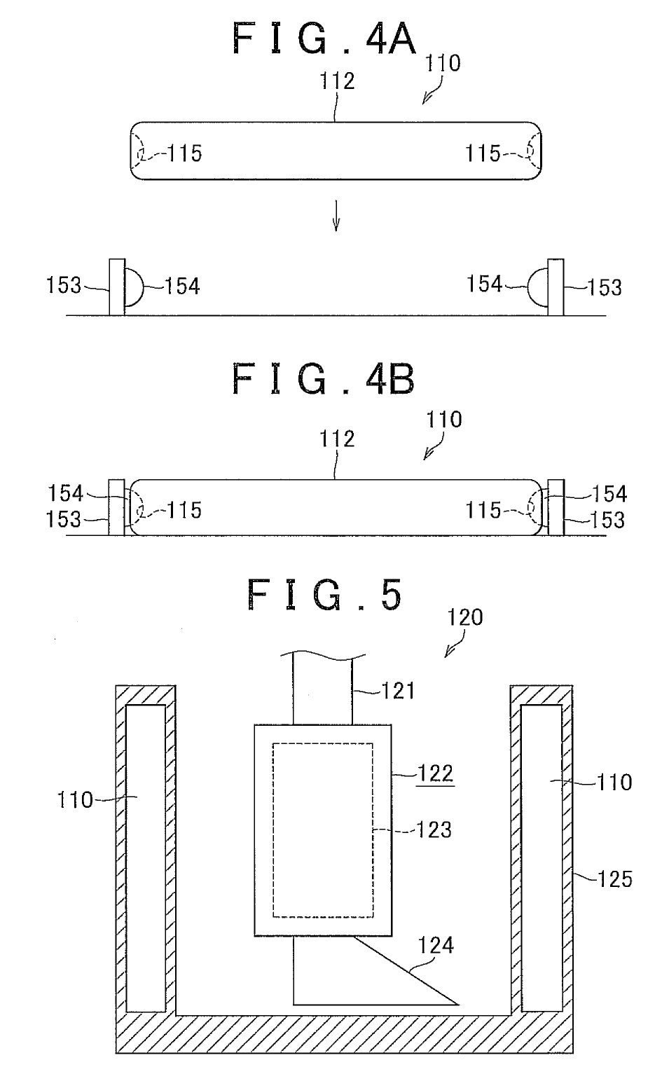

Another method may be used for fixing the latent heat storage material 110, as shown in FIG. 4. In this method, fixing members 153 are disposed in a place where the latent heat storage material 110 is fixed, and then the latent heat storage material 110 is press-fitted between the fixing members 153 as shown in FIG. 4B.

If this construction is used, in which the latent heat storage material 110 is press-fitted between the fixing members 153, as shown in FIG. 4A, it is preferred that a convex part 154 is provided in the fixing member 153 and that the a concave part 115, to which the convex part 154 of the fixing member 153 is fitted, is created on the outer peripheral surface of the container 112 of the latent heat storage material 110.

Press-fitting the latent heat storage material 110 between the fixing members 153 will make the fixing between the concave part 115 of the container 112 of the latent heat storage material 110 and the convex part 154 more suitable.

Temperature rise of the fuel can be prevented by using the latent heat from the phase-change substance 111 as long as the latent heat storage material 110 is arranged to be in contact with the fuel stored in the fuel tank 100. Therefore, the position to which the latent heat storage material 110 is fixed may appropriately be changed.

For example, as shown in FIG. 5, the latent heat storage material 110 may be fixed to the pump module 120. It does not matter which part of the pump module 120 the latent heat storage material 110 is placed on. However, for the purpose of effectively preventing the temperature rise of the fuel, it is preferred that the latent heat storage material 110 is fixed on the wall surface of the reserve cup 125 that surrounds the driving unit 122 including a motor 123 and a suction filter 124. In such a construction in which the latent heat storage material 110 is fixed to the wall surface of the reserve cup 125 that surrounds the driving unit 122, a contact area between the latent heat storage material 110 and the fuel can be kept large, so that the temperature rise of the fuel can be prevented effectively.

Also, as shown in FIG. 5 the latent heat storage material 110 may be arranged inside the wall surface of the reserve cup 125. Also, the latent heat storage material 110 may be fixed to the outer peripheral side or the inner peripheral side of the wall surface.

By the way, the resinous fuel tank is made from multilayer structured resin in which a barrier layer impermeable to fuel is interposed between other layers, since the fuel vapor needs to be prevented from permeating through the resinous tank wall into the outside air. Because of this, as described above with reference to FIG. 3, if the resinous fixing plate 150 integrally fixed to the latent heat storage material 110 is bonded to the resinous fuel tank, there might be a risk that the barrier layer is broken by the heat at the time of bonding.

For the purpose of preventing the damage to the barrier layer, other methods than bonding on the wall surface of the fuel tank may be employed when the latent heat storage material 110 is fixed on the inside of the resinous fuel tank.

Or if the latent heat storage material 110 is fixed to part of the pump module 120 arranged in the fuel tank as described above, the latent heat storage material 110 can be fixed in the fuel tank without damaging the barrier layer by bonding.

In the above embodiment, the number of the latent heat storage material 110 disposed in the fuel tank 100 is one. However, the number of the latent heat storage material 110 is not restrictive. For example, the latent heat storage material 110 may be fixed to both of the pump module 120 and the bottom surface of the inner peripheral side of the fuel tank 100.

In the above embodiment, the latent heat storage material 110 formed in the plate shape is disposed in the fuel tank 100. However, the present invention does not limit the shape of the latent heat storage material 110 to a plate shape only. Therefore, the shape of the latent heat storage material 110 may appropriately be modified.

In the above embodiment, paraffinic hydrocarbon is used as the phase-change substance 111. However, the phase-change substance 111 is not limited to paraffinic hydrocarbon. That is, the substance used as the phase-change substance 111 may appropriately be changed as long as its phase would change from a solid to a liquid in the use environment and its latent heat would prevent the fuel temperature rise.

In the above embodiment, the phase-change substance 111 is enclosed in the container 112 that is made of stainless steel. However, the material that forms the container 112 is not restrictive as long as it does not allow the phase-change substance 111 to permeate through the container 112. Also, the container 112 may be formed with a material other than metal.

However, for preventing the fuel temperature rise effectively, it is preferred that the container 112 is formed with a heat conductive material such as metal.

In the above embodiment, the discharge passage 220 is closed by the closing valve 221b to hermetically seal the fuel tank 100 while the engine is running. However, the present invention is not limited to the evaporated fuel processing device 200 that is provided with the closing valve 221b described above.

The fuel temperature rise and resultant forming of the fuel vapor can be prevented if the fuel tank 100 is at least provided with the latent heat storage material 110. Even if the closing valve 221b is not used, saturation of the adsorbent 211 can preferably be prevented at least in comparison to the conventional evaporated fuel processing device that is not provided with the latent heat storage material 110 in the fuel tank 100.

For the purpose of further preferably preventing the adsorbent 211 from being saturated and preventing the fuel vapor from being discharged from the outside air introduction passage 230, the closing valve 221b may be disposed to hermetically seal the fuel tank 100 while the engine is not running, as described above.

The constructions of the fuel tank 100 shown in the above embodiment only partly exemplifies an embodiment of the present invention. The temperature rise of fuel and the resultant forming of fuel vapor can be prevented as long as at least the latent heat storage material 110 is disposed in the fuel tank 100. That is, as long as the latent heat storage material 110 is disposed, the other constructions in the fuel tank 100 and the other constructions of the fuel vapor processing device 200 may appropriately be modified.

The fuel tank 100 according to the present invention and the fuel vapor processing device 200 that includes this fuel tank 100 may be installed in the vehicle with an idle reduction function such as a hybrid vehicle.

In the vehicle that has the idle reduction function, the internal combustion engine 10 is automatically stopped at the signal waiting at an intersection, for example. Because of this, the vehicle with the idling reduction function has a lot of opportunities for stopping the engine, and accordingly the purging is not executed frequently. Therefore, in the vehicle with the idling reduction function, the adsorbent 211 of the evaporated fuel processing device 200 tends to be saturated easily.

The fuel tank 100 according to the present invention may preferably be used in such a vehicle because the fuel tank 100 according to the present invention can prevent the forming of the fuel vapor. That is, saturation of the adsorbent 211 can be prevented even in the vehicle that has an idle reduction function with a tendency for less frequency of purging.

What is claimed is:

1. A fuel tank for storing a liquid fuel comprising a latent heat storage material that is disposed in the fuel tank and that encloses a phase-change substance which changes a phase from a solid to a liquid when a temperature of a stored fuel rises.

2. The fuel tank according to claim 1 wherein the latent heat storage material has the phase-change substance in a metallic container.

3. The fuel tank according to claim 1 wherein the phase-change substance is made from paraffinic hydrocarbon.

4. The fuel tank according to claim 3, wherein the paraffinic hydrocarbon includes any of pentadecane, hexadecane, octadecane, and henicosane.

5. The fuel tank according to claim 3, wherein a melting point of the phase-change substance is in a range of 0° C. to 40° C.

6. The fuel tank according to claim 1, wherein the latent heat storage material is fixed to a bottom surface on the inside of the fuel tank.

7. The fuel tank according to claim 1, wherein a pump module for pumping up the fuel stored in the fuel tank is at least partially immersed in the stored fuel, and the latent heat storage material is fixed to a portion of the pump module.

8. The fuel tank according to claim 7, wherein the pump module comprises a driving unit that is provided with a motor and a reserve cup that surrounds the driving unit, and the latent heat storage material is fixed to a wall surface of the reserve cup.

9. An evaporated fuel processing device comprising:
the fuel tank according to claim 1;
a canister that includes an adsorbent for adsorbing fuel vapor;
a discharge passage that connects the fuel tank and the canister;
a purge passage that connects an intake passage of an internal combustion engine and the canister; and
an outside air introduction passage that introduces air into the canister;
wherein the air in the canister is suctioned out into the intake passage by using a negative pressure in the intake passage, then air is introduced through the outside air introduction passage into the canister, thereby the fuel vapor adsorbed on the adsorbent is purged, and the purged fuel vapor is introduced in the intake passage together with the air to be burned in the internal combustion engine.

10. The evaporated fuel processing device according to claim 9, further comprising a closing valve that closes the discharge passage while the engine is not running, wherein the fuel tank is hermetically sealed while the engine is not running.
